(19) United States
(12) Patent Application Publication
(10) Pub. No.: US 2024/0319417 A1
(43) Pub. Date: Sep. 26, 2024

(54) WAVEGUIDE WITH ANTI-REFLECTION PROPERTIES

(71) Applicant: GOOGLE LLC, Mountain View, CA (US)

(72) Inventors: Timothy Paul Bodiya, Toronto (CA); Shreyas Potnis, Kitchener (CA); Daniel Adema, Kitchener (CA); Ian Andrews, Kitchener (CA); Syed Moez Haque, Vaughan (CA)

(21) Appl. No.: 18/574,956

(22) PCT Filed: Jun. 30, 2022
(86) PCT No.: PCT/US2022/035852

§ 371 Date: Dec. 28, 2023

Related U.S. Application Data
(60) Provisional application No. 63/217,594, filed on Jul. 1, 2021.

(51) Int. Cl. G02B 5/18; G02B 6/124; G02B 27/00; G02B 27/01

(52) U.S. Cl. CPC G02B 5/1809; G02B 5/1819; G02B 5/1842; G02B 6/124; G02B 27/0081; G02B 27/0172; G02B 2027/0178

(57) ABSTRACT

A head-mounted display system (100) includes a lens element (110) supported by a support structure (102). The lens element (110) includes a waveguide (212) to couple light from an image source. The waveguide (212) includes a waveguide surface (207) and a grating (250). The grating (250) is disposed onto the waveguide surface (207) and includes rows of three-dimensional, 3D, primitive structures (435), with a height of the 3D primitive structures being smaller than a wavelength of visible incident light at a surface of the sub-wavelength grating.

### CROSS-REFERENCE TO RELATED APPLICATIONS

The present application claims priority to U.S. Provisional Patent Application Ser. No. 63/217,594, entitled “WAVEGUIDES WITH IMPROVED ANTI REFLECTIVE AND/OR COLOR RESPONSE PROPERTIES” and filed on Jul. 1, 2021, the entirety of which is incorporated by reference herein.

### BACKGROUND

In a conventional wearable head-mounted display (HMD), light from an image source is coupled into a light guide substrate, generally referred to as a waveguide, by an input optical coupling such as an in-coupling grating (i.e., an “incoupler”), which can be formed on a surface, or multiple surfaces, of the substrate or disposed within the substrate. Once the light beams have been coupled into the waveguide, the light beams are “guided” through the substrate, typically by multiple instances of total internal reflection (TIR), to then be directed out of the waveguide by an output optical coupling (i.e., an “outcoupler”), which can also take the form of an optical grating. The light beams projected from the waveguide overlap at an eye relief distance from the waveguide forming an exit pupil within which a virtual image generated by the image source can be viewed by the user of the HMD.

Waveguides are typically flat and can exhibit reflections from the flat surface when embedded in augmented reality glasses having a curved prescription lens. When a light source and an external viewer are aligned at particular angles, the reflections can appear as flashes that are jarring, both for the user of the augmented reality glasses and the external viewer.

### SUMMARY OF THE EMBODIMENTS

In some embodiments, a system includes a waveguide to couple light from an image source. The waveguide includes a waveguide surface and a sub-wavelength grating. The sub-wavelength grating is disposed onto the waveguide surface and includes rows of three-dimensional (3D) primitive structures. A height of the 3D primitive structures is smaller than a wavelength of visible incident light at a surface of the sub-wavelength grating.

In some embodiments of the system, each of the rows of 3D primitive structures include repeating patterns of the 3D primitive structures, each of the repeating patterns of 3D primitive structures including a first 3D primitive structure and a second 3D primitive structure having at least one characteristic that differs from the first 3D primitive structure.

In some embodiments of the system, the at least one characteristic includes a shape, size, or height of the second 3D primitive structure.

In some embodiments of the system, the system includes at least one of an incoupler, an outcoupler, and an exit pupil expander. The repeating patterns of 3D primitive structures have a repeat period that is smaller than intervals of gratings of the incoupler, the outcoupler, and the exit pupil expander.

In some embodiments of the system, the sub-wavelength grating is configured to impart a phase that destructively interferes with light that reflects off the sub-wavelength grating.

In some embodiments, the sub-wavelength grating is configured to impart a phase that constructively interferes with light that is transmitted through the sub-wavelength grating.

In some embodiments, the 3D primitive structures include at least one of a cylindrical pillar, a cube, a cuboid, a hexagonal prism, a cone, a quadrilateral-base pyramid, a triangular-base pyramid, and a triangular prism.

In some embodiments, the sub-wavelength grating includes at least one layer sub-wavelength grating.

In some embodiments, a head-mounted display (HMD) system includes a lens element supported by a support structure. The lens element includes a waveguide to couple light from an image source. The waveguide includes a waveguide surface and sub-wavelength grating. The sub-wavelength grating is disposed onto the waveguide surface and includes rows of three-dimensional (3D) primitive structures. A height of the 3D primitive structures is smaller than a wavelength of visible incident light and a height of the 3D primitive structures is smaller than a wavelength of visible incident light at a surface of the sub-wavelength grating.

In some embodiments of the HMD, each of the rows of 3D primitive structures includes repeating patterns of the 3D primitive structures, each of the repeating patterns of 3D primitive structures including a first 3D primitive structure and a second 3D primitive structure having at least one characteristic that differs from the first 3D primitive structure.

In some embodiments of the HMD, the at least one characteristic includes a shape, size, or height of the second 3D primitive structure.

In some embodiments of the HMD, the HMD includes at least one of an incoupler, an outcoupler, and an exit pupil expander. The repeating patterns of 3D primitive structures have a repeat period that is smaller than intervals of gratings of the incoupler, the outcoupler, and the exit pupil expander.

In some embodiments of the HMD, the sub-wavelength grating is configured to impart a phase that destructively interferes with light that reflects off the sub-wavelength grating.

In some embodiments of the HMD, the sub-wavelength grating is configured to impart a phase that constructively interferes with light that is transmitted through the sub-wavelength grating.

In some embodiments of the HMD, the 3D primitive structures include at least one of a cylindrical pillar, a cube, a cuboid, a hexagonal prism, a cone, a quadrilateral-base pyramid, a triangular-base pyramid, and a triangular prism.

In some embodiments of the HMD, the sub-wavelength grating includes at least one layer sub-wavelength grating.

In some embodiments, a method includes receiving, by a waveguide surface of a waveguide, incident light, and mitigating reflection, by sub-wavelength grating, of the incident light from the waveguide surface of the waveguide. The sub-wavelength grating includes rows of three-dimensional (3D) primitive structures, wherein a height of the 3D primitive structures is smaller than a wavelength of visible incident light. A height of the 3D primitive structures is smaller than a wavelength of visible incident light at a surface of the sub-wavelength grating.

In some embodiments of the method, each of the rows of 3D primitive structures include repeating patterns of the 3D primitive structures, each of the repeating patterns of 3D primitive structures including a first 3D primitive structure and a second 3D primitive structure having at least one characteristic that differs from the first 3D primitive structure.

In some embodiments of the method, the at least one characteristic includes a shape, size, or height of the second 3D primitive structure.

In some embodiments of the method, the method further includes repeating a period of the repeating patterns of 3D primitive structures, the repeating period being smaller than intervals of gratings of an incoupler, an outcoupler, and an exit pupil expander.

In some embodiments of the method, the sub-wavelength grating is configured to impart a phase that destructively interferes with light that reflects off the sub-wavelength grating.

In some embodiments of the method, the sub-wavelength grating is configured to impart a phase that constructively interferes with light that is transmitted through the sub-wavelength grating.

In some embodiments of the method, the method further includes, for the 3D primitive structures, including at least one of a cylindrical pillar, a cube, a cuboid, a hexagonal prism, a cone, a quadrilateral-base pyramid, a triangular-base pyramid, and a triangular prism.

In some embodiments of the method, the sub-wavelength grating includes at least one layer sub-wavelength grating.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system having a waveguide with an anti-reflective grating to direct images toward the eye of a user, in accordance with some embodiments.

FIG. 2 illustrates a block diagram of a laser projection system that projects laser light representing images onto the eye of a user via a waveguide with an anti-reflective grating, in accordance with some embodiments.

FIG. 3 shows an example of light propagation within a waveguide of a laser projection system, such as the laser projection system of FIG. 2, in accordance with some embodiments.

FIG. 4 illustrates a magnified isometric view of an example anti-reflection grating including rows R of three-dimensional primitive structures, such as cubes, cuboids, and cylindrical pillars, disposed on a waveguide surface shown in FIGS. 2 and 3, in accordance with some embodiments.

FIG. 5 shows a magnified isometric view of another example anti-reflection grating including rows R of three-dimensional primitive structures, such as cubes, cylindrical pillars, and cuboids, disposed on the waveguide surface shown in FIGS. 2 and 3, in accordance with some embodiments.

FIG. 6 illustrates a magnified isometric view of yet another example anti-reflection grating including rows R of three-dimensional primitive structures, such as quadrilateral-base pyramids and triangular prisms (prism-shaped, not acting as a prism), disposed on the waveguide surface shown in FIGS. 2 and 3, in accordance with some embodiments.

FIG. 7 shows examples of primitive structures that form the anti-reflection grating including a cylindrical pillar, a cube, a cuboid, a hexagonal prism, a cone, a quadrilateral-base pyramid, a triangular-base pyramid, and a triangular prism, in accordance with some embodiments.

FIG. 8 shows a block diagram of an example method to mitigate reflection from the waveguide shown in FIGS. 2 and 3, and particularly a waveguide surface, in accordance with some embodiments.

### DETAILED DESCRIPTION

In some HMDs, the incoupler is an optical grating, which can be produced by physically forming grooves or other surface features on a surface of a waveguide, or volume features within the waveguide substrate. The overall efficiency of a grating depends on various application-specific parameters such as wavelength, polarization, and angle of incidence of the incoming light. The efficiency of a grating is also influenced by the grating design parameters, such as the distance between adjacent grating features (referred to as a pitch or period), grating width, thickness of the grating region, and the angle the gratings form with the substrate.

Anti-reflection coatings are used to minimize the visibility of flashes of reflection from a waveguide. Typically, this is done by depositing layers of thin-films on a waveguide substrate of the waveguide. The number of layers, layer material, and layer thickness determines the reflection properties. However, this typical deposition of layers of thin-films on a waveguide substrate of the waveguide is minimally tunable, particularly for applications with a wearable head-mounted display (HMD). In addition, simultaneous optimization of the performance of the anti-reflection coatings on both grating and non-grating areas of the waveguide is not always possible.

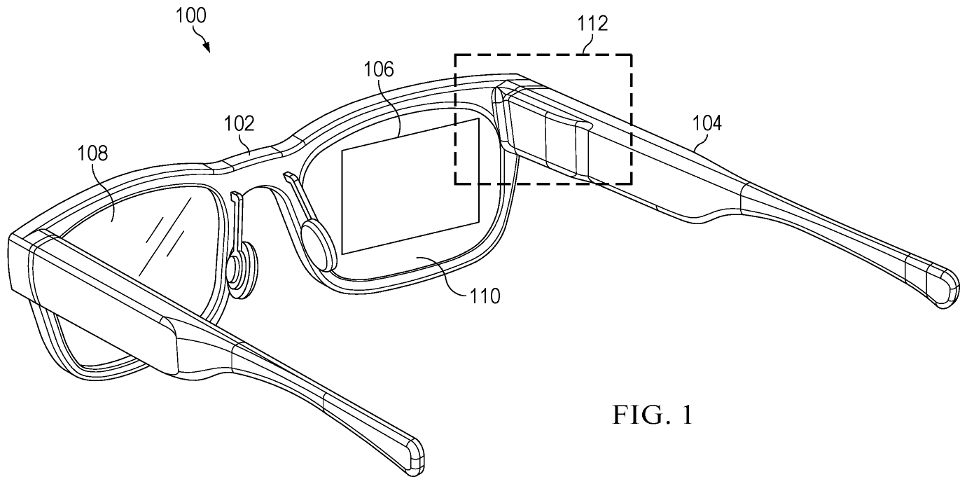

FIGS. 1-8 illustrate techniques to minimize reflections from the waveguide without interfering with the grating areas of the waveguide by using highly sub-wavelength anti-reflection gratings formed in a single layer on a surface of the waveguide that are made up of repeating patterns of three-dimensional (3D) primitive structures. Using sub-wavelength gratings ensures that there is no diffraction from the grating areas. The anti-reflective gratings provide destructive interference for reflected light while providing constructive interference for light that is transmitted through the anti-reflection grating. The geometry of the primitive structures-shape, size, period, and complexity (different combinations of shapes, sizes (length, width, height), and period) are parameters that can be tuned to optimize the anti-reflection performance of the anti-reflection grating. For example, adjusting the geometry of the primitive structures tunes anti-reflection performance over an angle of incidence and wavelength range that is beyond what can be achieved by the typical layers of thin-films. In some embodiments, the height of the primitive structures is smaller than a wavelength of visible incident light at a surface of the sub-wavelength anti-reflection grating.

In some embodiments, the 3D primitive structures are arranged in rows of repeating patterns. Each of the repeating patterns of 3D primitive structures includes at least two different 3D primitive structures having characteristics that differ from each other. For example, the 3D primitive structures differ in shape, size, or height from each other. The 3D primitive structures include at least one of a cylindrical pillar, a cube, a cuboid, a hexagonal prism, a cone, a quadrilateral-base pyramid, a triangular-base pyramid, and a triangular prism. In some embodiments, the repeating patterns of 3D primitive structures have a repeat period that is smaller than the intervals of the gratings of the incoupler, the outcoupler, and the exit pupil expander of the waveguide. The pitch and characteristics of the 3D primitive structures of the sub-wavelength grating impart a phase that causes destructive interference for light that is reflected off the sub-wavelength grating and constructive interference for light that is transmitted through the sub-wavelength grating in some embodiments.

The anti-reflection grating is configured to not impact the display or “see-thru” properties that are experienced by a user of the HMD, but only to minimize reflections from the waveguide that would otherwise be visible to an external viewer of the HMD. Also, the primitive structures can be formed from the same fabrication process that is used to form gratings on other portions of the waveguide, with only a few additional fabrication steps to arrive at desired three-dimensional shapes for the primitive structures.

FIG. 1 illustrates an example display system 100 having a waveguide with an anti-reflective grating to direct images toward the eye of a user, such that the user perceives the projected images as being displayed in a field of view (FOV) area 106 of a display at one or both of lens elements 108, 110. In the depicted configuration, the display system 100 is a wearable head-mounted display (HMD) that includes a support structure 102 configured to be worn on the head of a user and has a general shape and appearance of an eyeglasses frame. The support structure 102 contains or otherwise includes various components to facilitate the projection of such images toward the eye of the user, such as a laser projector, an optical scanner, and a waveguide.

In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) or mixed reality (MR) display in which rendered graphical content can be superimposed over or otherwise provided in conjunction with a real-world view as perceived by the user through the lens elements 108, 110. For example, laser light used to form a perceptible image or series of images may be projected by a laser projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler, or multiple incouplers, of the waveguide to an outcoupler of the waveguide, which outputs the display light toward an eye of a user of the display system 100. The display light is modulated and projected onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment. Typically, the lens elements 108, 110 are curved. A waveguide associated with the lens elements 108, 110 is typically formed on a flat plane. When viewed by an external viewer of the HMD, these different angles produce different reflections that result in aberrations to the external viewer. These aberrations allow the external viewer to perceive the presence of the waveguide, an undesirable trait for the HMD. Mitigating such reflections mitigates such aberrations, making the lens elements 108, 110 appear as conventional lens elements on typical eyeglasses. An anti-reflection grating discussed in detail below performs such mitigations.

In some embodiments, the projector is a matrix-based projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106 and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, the projector routes light via first and second scan mirrors, an optical relay disposed between the first and second scan mirrors, and a waveguide disposed at the output of the second scan mirror. In some embodiments, at least a portion of an outcoupler of the waveguide may overlap the FOV area 106. These aspects are described in greater detail below.

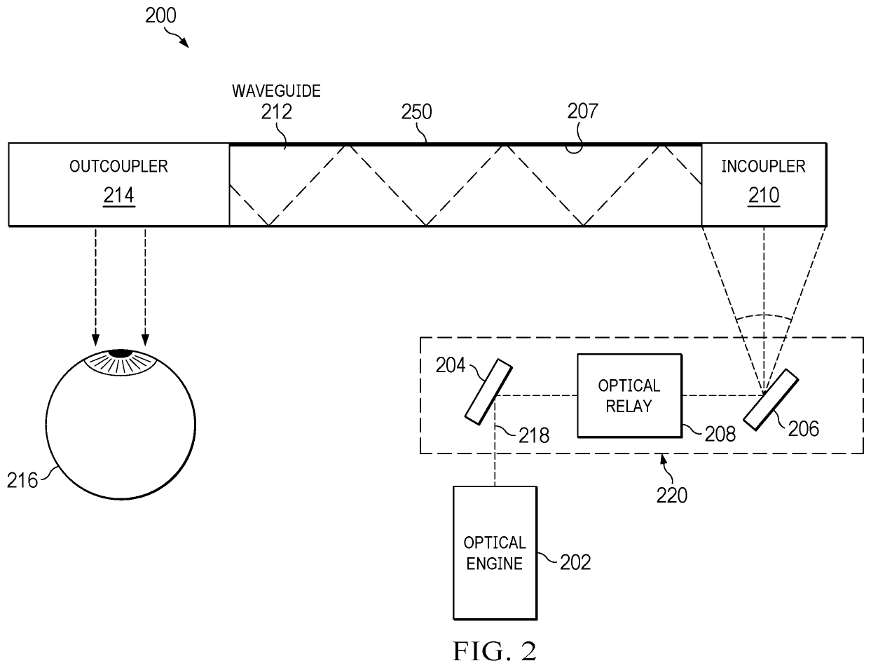

FIG. 2 illustrates a block diagram of a laser projection system 200 that projects laser light representing images onto the eye 216 of a user via a waveguide, such as that illustrated in FIG. 1. The laser projection system 200 includes an optical engine 202, an optical scanner 220, and a waveguide 212. In some embodiments, the laser projection system 200 is implemented in a wearable heads-up display or other display systems.

The optical engine 202 includes one or more laser light sources configured to generate and output laser light (e.g., visible laser light such as red, blue, and green laser light and/or non-visible laser light such as infrared laser light). In some embodiments, the optical engine 202 is coupled to a controller or driver (not shown), which controls the timing of emission of laser light from the laser light sources of the optical engine 202 (e.g., in accordance with instructions received by the controller or driver from a computer processor coupled thereto) to modulate the laser light 218 to be perceived as images when output to the retina of the eye 216 of the user.

The optical scanner 220 includes a first scan mirror 204, a second scan mirror 206, and an optical relay 208. One or both of the scan mirrors 204 and 206 may be MEMS mirrors, in some embodiments. For example, the scan mirror 204 and the scan mirror 206 are MEMS mirrors that are driven by respective actuation voltages to oscillate during active operation of the laser projection system 200, causing the scan mirrors 204 and 206 to scan the laser light 218. Oscillation of the scan mirror 204 causes laser light 218 output by the optical engine 202 to be scanned through the optical relay 208 and across a surface of the second scan mirror 206. The second scan mirror 206 scans the laser light 218 received from the scan mirror 204 toward an incoupler 210 of the waveguide 212. In some embodiments, the scan mirror 204 oscillates along a first scanning axis, such that the laser light 218 is scanned in only one dimension (i.e., in a line) across the surface of the second scan mirror 206. In some embodiments, the scan mirror 206 oscillates along a second scan axis that is perpendicular to the first scan axis.

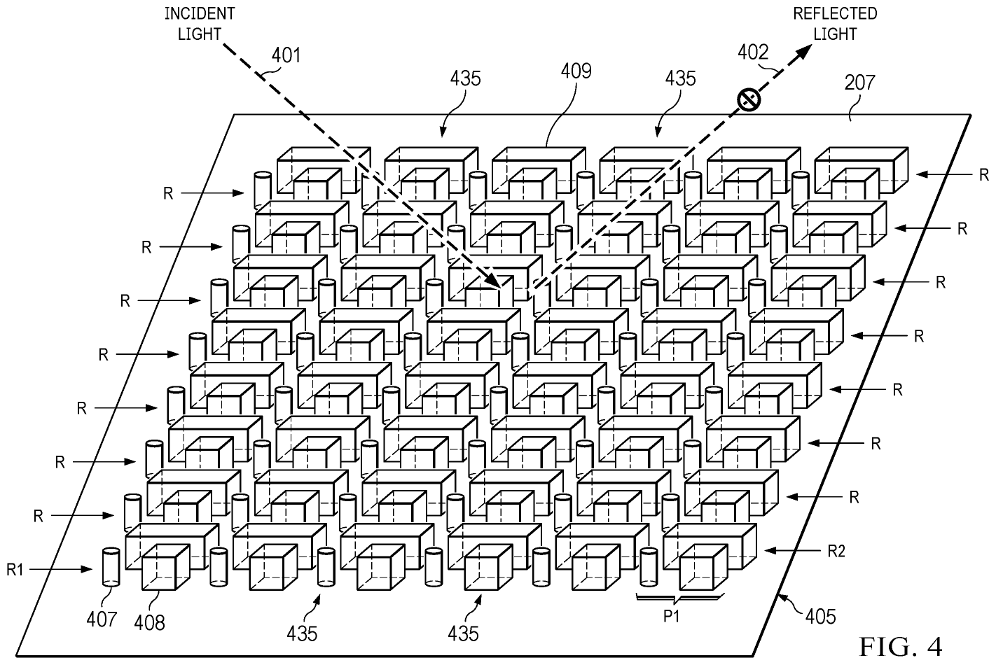

The waveguide 212 of the laser projection system 200 includes the incoupler 210 and the outcoupler 214. The term “waveguide,” as used herein, will be understood to mean a combiner using total internal reflection (TIR), or via a combination of TIR, specialized filters, and/or reflective surfaces, to transfer light from an incoupler to an outcoupler. For display applications, the light may be a collimated image, and the waveguide transfers and replicates the collimated image to the eye. In general, the terms “incoupler” and “outcoupler” will be understood to refer to any type of optical grating structure, including, but not limited to, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive diffraction grating that causes the incoupler or outcoupler to transmit light and to apply designed optical function(s) to the light during the transmission. In some embodiments, a given incoupler or outcoupler is a reflective diffraction grating that causes the incoupler or outcoupler to reflect light and to apply designed optical function(s) to the light during the reflection. In the present example, the laser light 218 received at the incoupler 210 is relayed to the outcoupler 214 via the waveguide 212 using TIR. The laser light 218 is then output to the eye 216 of a user via the outcoupler 214. The waveguide 212 further includes the anti-reflection grating 250 that is disposed on a waveguide surface 207. As will be shown in more detail in FIGS. 4-7, the anti-reflection grating 250 includes rows of three-dimensional primitive structures that are disposed onto the waveguide surface 207, the anti-reflection grating 250 being a sub-wavelength grating. In some embodiments, the anti-reflection grating 250 can be disposed on both sides of the waveguide 212. Different combinations of these primitive structures can be used to obtain desired anti-reflection characteristics (e.g., reflection amplitude, reflection phase or how reflection changes as a function of wavelength), providing good nano-band performance, not just good for one wavelength, but balancing performance for all wavelengths. The anti-reflection grating 250 is a single layer sub-wavelength grating (although a multi-layer sub-wavelength grating is possible)—that is, the pitch or period (repeating pattern of primitive structures) of the anti-reflection grating 250 is small relative to a wavelength of visible incident light at the surface of the anti-reflection grating 250 such that the anti-reflection grating 250 does not reflect light but changes the reflection and transmission properties of the light at the waveguide surface 207. The period of the anti-reflection grating 250 is also smaller than periods of gratings of the incoupler 210, outcoupler 214, and exit pupil expander 304.

In some embodiments, incoupler 210 is a substantially rectangular feature configured to receive the laser light 218 and direct the laser light 218 into the waveguide 212. The incoupler 210 may be defined by a small dimension (i.e., width) and a long dimension (i.e., length). In a configuration, the optical relay 208 is a line-scan optical relay that receives the laser light 218 scanned in a first dimension by the first scan mirror (e.g., the first dimension corresponding to the small dimension of the incoupler 210), routes the laser light 218 to the second scan mirror 206, and introduces a convergence to the laser light 218 in the first dimension. The second scan mirror 206 receives the converging laser light 218 and scans the laser light 218 in a second dimension, the second dimension corresponding to the long dimension of the incoupler 210 of the waveguide 212. The second scan mirror may cause the laser light 218 to converge to a focal line along the second dimension. In some embodiments, the incoupler 210 is positioned at or near the focal line downstream from the second scan mirror 206 such that the second scan mirror 206 scans the laser light 218 as a line over the incoupler 210.

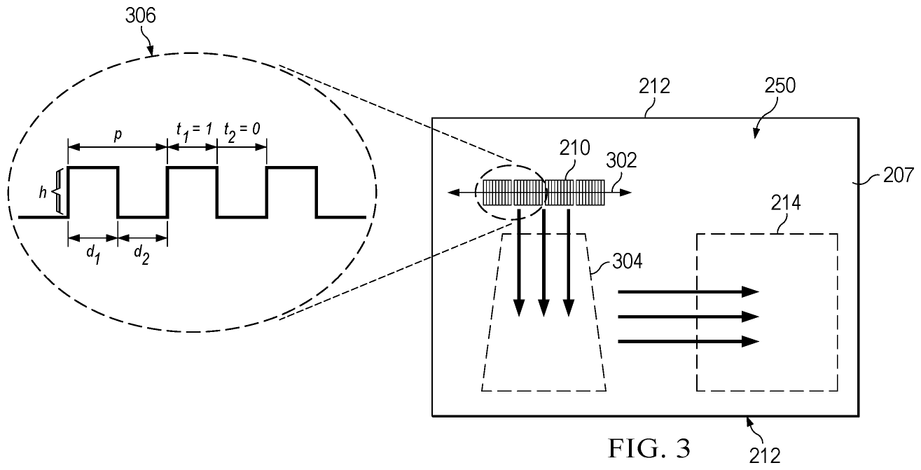

FIG. 3 shows an example of light propagation within the waveguide 212 of the laser projection system 200 of FIG. 2. As shown, light is received via incoupler 210, scanned along the axis 302, directed into an exit pupil expander 304, and then routed to the outcoupler 214 to be output from the waveguide 212 (e.g., toward the eye of the user). In some embodiments, the exit pupil expander 304 expands one or more dimensions of the eyebox of an HMD that includes the laser projection system 200 (e.g., with respect to what the dimensions of the eyebox of the HMD would be without the exit pupil expander 304). In some embodiments, the incoupler 210 and the exit pupil expander 304 each include respective one-dimensional diffraction gratings (i.e., diffraction gratings that extend along one dimension). It should be understood that FIG. 3 shows a substantially ideal case in which incoupler 210 directs light straight down (with respect to the presently illustrated view) in a first direction that is perpendicular to the scanning axis 302, and the exit pupil expander 304 directs light to the right (with respect to the presently illustrated view) in a second direction that is perpendicular to the first direction. While not shown in the present example, it should be understood that, in some embodiments, the first direction in which the incoupler 210 directs light is slightly or substantially diagonal, rather than exactly perpendicular, with respect to the scanning axis 302.

Also shown in FIG. 3 is a cross-section 306 of incoupler 210 illustrating features of the grating that can be configured to tune the efficiency of incoupler 210. The period p of the grating is shown having two regions, with transmittances t1=1 and t2=0 and widths d1 and d2, respectively. The grating period is constant p=d1+d2, but the relative widths d1, d2 of the two regions may vary. A fill factor parameter x can be defined such that d1=xp and d2=(1−x)p. In addition, while the profile shape of the grating features in cross-section 306 is generally shown as being square or rectangular with a height h, the shape can be modified based on the wavelength of light that incoupler 210 is intended to receive. For example, in some embodiments, the shape of the grating features is triangular, rather than square, to create a more “saw-toothed” profile. In some embodiments, incoupler 210 is configured as a grating with a constant period but different fill factors, heights, and slant angles based on the desired efficiency of the respective incoupler 210 or the desired efficiency of a region of the respective incoupler 210.

In some embodiments, the anti-reflection grating 250 is positioned in an area of the waveguide 212 between the exit pupil expander 304 and the outcoupler 214 to facilitate mitigation of reflection of light incident on the waveguide 212 without interfering with the diffraction gratings of the incoupler 210, the exit pupil expander 304, and the outcoupler 214. In addition, and in contrast to an anti-reflection coating, the anti-reflection grating 250 does not affect the color and intensity of reflections from the areas of the incoupler 210, the exit pupil expander 304, and the outcoupler 214.

FIG. 4 illustrates a magnified isometric view of an example anti-reflection grating 405 including rows R of three-dimensional primitive structures 435, such as cubes, cuboids, and cylindrical pillars, disposed on the waveguide surface 207, in accordance with some embodiments. An incident light 401 is shown as striking the anti-reflection grating 405. The anti-reflection grating 405 prevents reflection of reflected light 402 from the anti-reflection grating 405. As can be seen, the pattern of three-dimensional primitive structures 435 repeats in 2 dimensions (2-D), that is within each row R and in multiple rows R. The periods of the primitive structures 435 are sized to prevent the diffraction of light entering the anti-reflection grating 405.

In this example, there are two different row patterns of the three-dimensional primitive structures 435. As shown, row R1 includes a plurality of cylindrical pillars 407 and a plurality of cubes 409, with a pair of a single cylindrical pillar 407 and a single cube 409, together forming a single period configuration P1. This period configuration P1 is repeated across row R1 until row R1 is the desired width. Row R2 includes a cuboid 409 that is formed “lying down” on the longest side of the cuboid 409. The cylindrical pillar 407, the cube 409, and the cuboid 409 are all substantially a same height in this example, with variations due to manufacturing inconsistencies possible. Row R2 in this example only includes the cuboids 409. The anti-reflection grating 405 is formed by alternatively repeating row R1 and row R2 until a desired area is filled with the anti-reflection grating 405. Although anti-reflection grating 405 is shown as having two different configurations for the alternating repeating rows R1, R2, the number of different rows is not limited. The number of different configurations for the alternating repeating rows R for an anti-reflection grating can include three or more different configurations for alternating repeating rows R of the three-dimensional primitive structures 435.

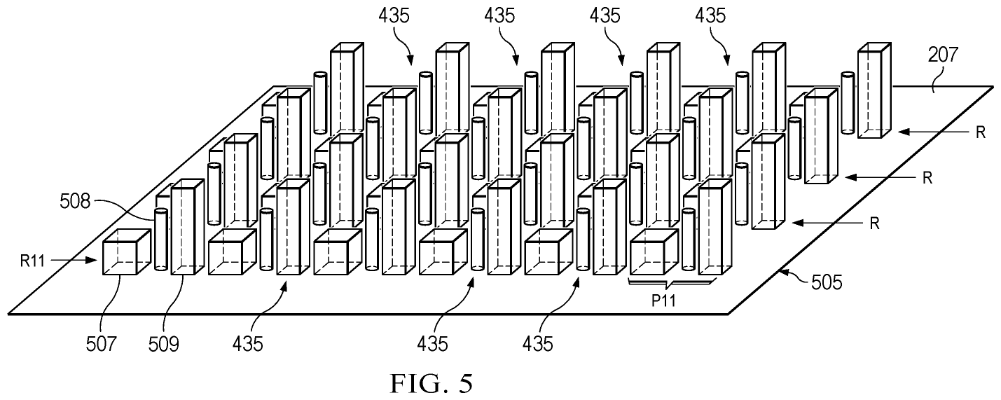

FIG. 5 shows a magnified isometric view of another example anti-reflection grating 505 including rows R of three-dimensional primitive structures 435, such as cubes, cylindrical pillars, and cuboids, disposed on the waveguide surface 207, in accordance with some embodiments. In this example, a single row pattern of the three-dimensional primitive structures 435 is repeated for all of the rows R of the anti-reflection grating 505. As shown, row R11 includes a plurality of cubes 507, a plurality of cylindrical pillars 508, a plurality of cuboids 509, with a threesome of an ordered (ordered from left to right) single cube 507, single cylindrical pillar 508, and single cuboid 509 together forming a single period configuration P11. In contrast to cuboid 409, cuboid 507 is formed “standing” on the shortest side of the cuboid 507. This period configuration P11 is repeated across row R11 until row R11 is a desired width, with the rest of the rows R also including this same repeating period configuration P11.

In contrast to the anti-reflection grating 505 in which all of the three-dimensional primitive structures 435 forming the anti-reflection grating 405 are approximately a same height, the three-dimensional primitive structures 435 of the anti-reflection grating 505 are formed from the three-dimensional primitive structures 435 that vary in height. The cube 507 is shown as being the shortest of the three-dimensional primitive structures 435 and the cuboid 509 is shown as being the tallest of the three-dimensional primitive structures 435, with the cylindrical pillar 508 having a height in-between heights of the cube 507 and the cuboid 509.

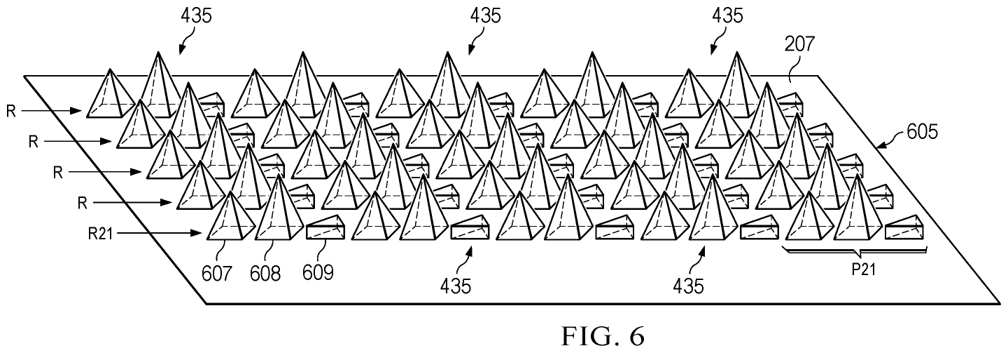

FIG. 6 illustrates a magnified isometric view of yet another example anti-reflection grating 605 including rows R of three-dimensional primitive structures 435, such as quadrilateral-base pyramids and triangular prisms (prism-shaped, not acting as a prism), disposed on the waveguide surface 207, in accordance with some embodiments. In this example, again there is a single row pattern of the three-dimensional primitive structures 435 that is repeated for all of the rows R of the anti-reflection grating 605. As shown, row R21 includes a plurality of shorter quadrilateral-base pyramids 607, a plurality of taller quadrilateral-base pyramids 608 (taller with respect to the shorter quadrilateral-base pyramids 607), and a plurality of triangular prisms 608. Thus, a threesome of an ordered (ordered from left to right) single shorter quadrilateral-base pyramid 607, single taller quadrilateral-base pyramid 608, and single triangular prism 609 together form a single period configuration P21. This period P21 is repeated across row R21 until row R21 is a desired width, with the rest of the rows R of the anti-reflection grating 605 including this same repeating period configuration P21.

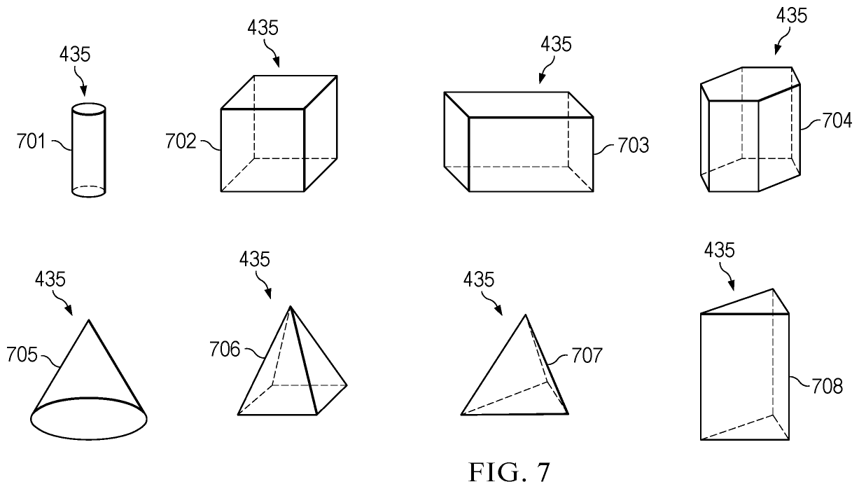

The anti-reflection gratings 405-605 are shown as being formed from cylindrical pillars, cubes, cuboids, quadrilateral-base pyramids, and triangular prisms. However, anti-reflection gratings can be formed from a single three-dimensional structure that is repeated across rows R or a combination of different shaped (and/or sized) three-dimensional primitive structures that are repeated across rows from any three-dimensional primitive structures that can be formed onto the waveguide surface 207, not limited to those shown herein as examples. FIG. 7 shows a magnified view of examples of variously shaped primitive structures 435 that can be used to form an anti-reflection grating. In particular, FIG. 7 shows the primitive structures 435 that form an anti-reflection grating including a cylindrical pillar 701, a cube 702, a cuboid 703, a hexagonal prism 704 (hexagonal prism-shaped, not acting as a prism), a cone 705, a quadrilateral-base pyramid 706, a triangular-base pyramid 707, and a triangular prism 708 (triangular prism-shaped, not acting as a prism). Each of these variously shaped primitive structures 435 can be formed at various sizes, that is at a desired height, a desired width, and a desired length. As there are nearly unlimited combinations of shapes and sizes for the primitive structures 435, in some embodiments a simulator is used to assist with determining an optimal combination of shapes and sizes for the primitive structures 435 to form an anti-reflection grating.

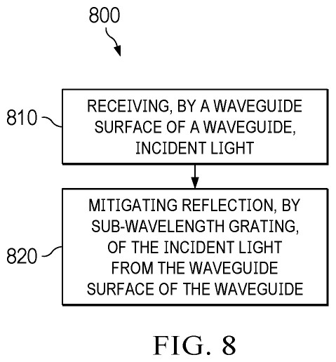

FIG. 8 shows a block diagram of an example method 800 to mitigate reflection from the waveguide 212 shown in FIGS. 2 and 3, and particularly the waveguide surface 207, in accordance with some embodiments.

Method 800 begins at block 810. At block 810, the waveguide surface 207 receives incident light, such as the incident light 401. At block 820, the anti-reflection grating 250 mitigates reflection of the incident light 401 from the waveguide surface 207. In some embodiments, the anti-reflection grating 250 (or any of the other anti-reflection gratings 405, 505, 605) is a single layer sub-wavelength grating including rows of three-dimensional primitive structures 435 disposed onto the waveguide surface 207. These primitive structures 435 of the method 800 can take on various shapes and sizes, such as those described above for FIG. 7. The anti-reflection grating 250 imparts a phase that destructively interferes with reflected light and constructively interferes with transmitted light in some embodiments, thereby minimizing the visibility of flashes of reflection from the waveguide 212.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A system comprising:
a waveguide to couple light from an image source, the waveguide comprising:
a waveguide surface; and
a sub-wavelength grating disposed onto the waveguide surface, the sub-wavelength grating comprising rows of three-dimensional (3D) primitive structures, wherein a height of the 3D primitive structures is smaller than a wavelength of visible incident light at a surface of the sub-wavelength grating.

2. The system of claim 1, wherein each of the rows of 3D primitive structures comprise repeating patterns of the 3D primitive structures, each of the repeating patterns of 3D primitive structures comprising a first 3D primitive structure and a second 3D primitive structure having at least one characteristic that differs from the first 3D primitive structure.

3. The system of claim 2, wherein the at least one characteristic comprises a shape, size, or height of the second 3D primitive structure.

4. The system of claim 1, further comprising at least one of:
an incoupler;
an outcoupler; and
an exit pupil expander,
wherein the repeating patterns of 3D primitive structures have a repeat period that is smaller than intervals of gratings of the incoupler, the outcoupler, and the exit pupil expander.

5. The system of claim 1, wherein the sub-wavelength grating is configured to impart a phase that destructively interferes with light that reflects off the sub-wavelength grating.

6. The system of claim 1, wherein the sub-wavelength grating is configured to impart a phase that constructively interferes with light that is transmitted through the sub-wavelength grating.

7. The system of claim 1, wherein the 3D primitive structures include at least one of a cylindrical pillar, a cube, a cuboid, a hexagonal prism, a cone, a quadrilateral-base pyramid, a triangular-base pyramid, and a triangular prism.

8. The system of claim 1, wherein the sub-wavelength grating is comprised of at least one layer sub-wavelength grating.

9. A head-mounted display (HMD) system comprising:
a lens element supported by a support structure, the lens element including a waveguide to couple light from an image source, the waveguide comprising:
a waveguide surface; and
a sub-wavelength grating disposed onto the waveguide surface, the sub-wavelength grating comprising rows of three-dimensional (3D) primitive structures, wherein a height of the 3D primitive structures is smaller than a wavelength of visible incident light, wherein a height of the 3D primitive structures is smaller than a wavelength of visible incident light at a surface of the sub-wavelength grating.

10. The HMD of claim 9, wherein each of the rows of 3D primitive structures comprises repeating patterns of the 3D primitive structures, each of the repeating patterns of 3D primitive structures comprising a first 3D primitive structure and a second 3D primitive structure having at least one characteristic that differs from the first 3D primitive structure.

11. The HMD of claim 10, wherein the at least one characteristic comprises a shape, size, or height of the second 3D primitive structure.

12. The HMD of claim 10, further comprising at least one of:
an incoupler;
an outcoupler; and
an exit pupil expander,
wherein the repeating patterns of 3D primitive structures have a repeat period that is smaller than intervals of gratings of the incoupler, the outcoupler, and the exit pupil expander.

13. The HMD of claim 9, wherein the sub-wavelength grating is configured to impart a phase that destructively interferes with light that reflects off the sub-wavelength grating.

14. The HMD of claim 9, wherein the sub-wavelength grating is configured to impart a phase that constructively interferes with light that is transmitted through the sub-wavelength grating.

15. The HMD of claim 9, wherein the 3D primitive structures include at least one of a cylindrical pillar, a cube, a cuboid, a hexagonal prism, a cone, a quadrilateral-base pyramid, a triangular-base pyramid, and a triangular prism.

16. The HMD of claim 9, wherein the sub-wavelength grating is comprised of at least one layer sub-wavelength grating.

17. A method comprising:
receiving, by a waveguide surface of a waveguide, incident light; and
mitigating reflection, by sub-wavelength grating, of the incident light from the waveguide surface of the waveguide;
wherein the sub-wavelength grating comprises rows of three-dimensional (3D) primitive structures, wherein a height of the 3D primitive structures is smaller than a wavelength of visible incident light; and
wherein a height of the 3D primitive structures is smaller than a wavelength of visible incident light at a surface of the sub-wavelength grating.

18. The method of claim 17, wherein each of the rows of 3D primitive structures comprise repeating patterns of the 3D primitive structures, each of the repeating patterns of 3D primitive structures comprising a first 3D primitive structure and a second 3D primitive structure having at least one characteristic that differs from the first 3D primitive structure.

19. The method of claim 18, wherein the at least one characteristic comprises a shape, size, or height of the second 3D primitive structure.

20. The method of claim 18, further comprising repeating a period of the repeating patterns of 3D primitive structures, the repeating period being smaller than intervals of gratings of an incoupler, an outcoupler, and an exit pupil expander.

21. The method of claim 17, wherein the sub-wavelength grating is configured to impart a phase that destructively interferes with light that reflects off the sub-wavelength grating.

22. The method of claim 17, wherein the sub-wavelength grating is configured to impart a phase that constructively interferes with light that is transmitted through the sub-wavelength grating.

23. The method of claim 17, further comprising including, for the 3D primitive structures, at least one of a cylindrical pillar, a cube, a cuboid, a hexagonal prism, a cone, a quadrilateral-base pyramid, a triangular-base pyramid, and a triangular prism.

24. The method of claim 17, wherein the sub-wavelength grating is comprised of at least one layer sub-wavelength grating.
